(19) United States
(12) Patent Application Publication
(10) Pub. No.: US 2006/0165566 A1
(43) Pub. Date: Jul. 27, 2006

(54) Loop reactor design

(75) Inventor: Charles Kelm, Crosby, TX (US)

Correspondence Address: David J. Alexander, P.O. Box 674412, Houston, TX, 77167, US

(73) Assignee: Fina Technology, Inc., Houston, TX (US)

(21) Appl. No.: 11/264,905

(22) Filed: Nov. 2, 2005

Related U.S. Application Data
(60) Provisional application No. 60/646,675, filed on Jan. 25, 2005.

(51) Int. Cl. B01J 19/18

(52) U.S. Cl. 422/132; 526/64

(57) ABSTRACT

Loop reactors are described herein. The loop reactors generally include a lower horizontal segment, an upper horizontal segment and a vertical segment in operable communication and an in-line pump incorporated within the loop reactor.

### CROSS-REFERENCE TO RELATED APPLICATIONS

This application claims the benefit of U.S. Provisional Patent Application Ser. No. 60/646,675, filed Jan. 25, 2005.

### FIELD

Embodiments of the present invention generally relate to loop reactors. In particular, embodiments described herein generally relate to systems and methods for circulating a process stream within a loop reactor.

### BACKGROUND

Loop reactors generally include a circulating pump partially disposed therein to circulate a process stream therethrough. A portion of the circulating pump is generally disposed within the loop reactor via an aperture formed therethrough. Therefore, seals are generally employed to prevent the passage of the process stream through any portion of the aperture.

Unfortunately, such seals have a limited lifetime, often requiring maintenance, which may lead to lost production time and potentially hazardous conditions, for example.

Therefore, a need exists for a method and system of circulating a fluid within a loop reactor while minimizing maintenance and hazardous conditions as a result thereof.

### SUMMARY

Embodiments of the present invention include loop reactors, such loop reactors generally including a lower horizontal segment, an upper horizontal segment and a vertical segment in operable communication with each other and an in-line pump incorporated within the loop reactor.

Another embodiment includes a polymerization process, such polymerization process including contacting an olefin monomer with a catalyst disposed in a process stream, wherein the process stream is disposed within a loop reactor and passing the process stream through an in-line pump to circulate the process stream through the loop reactor.

Embodiments of the invention further include a process for retrofitting a loop reactor with a circulating pump, the process including adapting a loop reactor having a lower horizontal segment, a vertical segment and a pump portion to incorporate an in-line pump therein and operably connecting the in-line pump to the loop reactor.

### BRIEF DESCRIPTION OF DRAWINGS

FIG. 1 illustrates a portion of a loop reactor.

FIG. 2 illustrates a portion of a loop reactor including a circulating pump.

FIG. 3 illustrates an embodiment of an in-line pump.

FIG. 4 illustrates embodiments of in-line pump placement

FIG. 5 illustrates embodiments of in-line pump supports.

### DETAILED DESCRIPTION

### INTRODUCTION AND DEFINITIONS

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

The term “in-line pump” generally refers to a circulating pump adapted to pass a process stream substantially therethrough, For example, the in-line pump may include a spool-type pump, but not a pump wherein a portion of the pump is operably connected to the loop reactor via insertion through an aperture formed therein.

The term “metallocene activator” is defined to be any compound or combination of compounds, supported or unsupported, which may activate a single-site catalyst compound (e.g., metallocenes, Group 15 containing catalysts, etc.)

Although not shown herein, the process stream flow may be modified based on unit optimization so long as the modification complies with the spirit of the invention, as defined by the claims. For example, at least a portion of any overhead fraction may be recycled as input to any other system within the process. Also, additional process equipment, such as heat exchangers, may be employed throughout the processes described herein and such placement is generally known to one skilled in the art.

Further, while described below in terms of primary components, the streams indicated below may include any additional components as known to one skilled in the art.

Embodiments of the invention generally include circulating a process stream within a loop reactor. It is contemplated that the embodiments of the invention described in further detail below may be used in any loop reactor system. In a specific embodiment, the loop reactor is used to form a polymer. For example, the loop reactor may be used to form a polyolefin.

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene), for example. The medium employed is generally liquid under the conditions of polymerization and relatively inert. A bulk phase process is similar to that of a slurry process. However, a process may be a bulk process, a slurry process or a bulk slurry process, for example.

In a specific embodiment, a slurry process or a bulk process may be carried out continuously in one or more loop reactors. A catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bars to about 45 bars and a temperature of from about 38° C. to about 121° C., for example. Reaction heat may be removed through the loop wall via any method known to one skilled in the art, such as via a double-jacketed pipe, for example. However, the equipment, process conditions, reactants, additives and other materials used in polymerization processes will vary in a given process, depending on the desired composition and properties of the polymer being formed.

Catalyst systems useful for polymerizing olefin monomers generally include any catalyst system known to one skilled in the art. For example, the catalyst system may include metallocene catalyst systems, single site catalyst systems, Ziegler-Natta catalyst systems or combinations thereof, for example. A brief discussion of such catalyst systems is included below, but is in no way intended to limit the scope of the invention to such catalysts.

Ziegler-Natta catalyst systems are generally formed from the combination of a metal component (e.g., a catalyst) with one or more additional components, such as a catalyst support, a cocatalyst and/or one or more electron donors, for example.

A specific example of a Ziegler-Natta catalyst includes a metal component generally represented by the formula:
MRₓ;
wherein M is a transition metal, R is a halogen, an alkoxy, or a hydrocarboxyl group and x is the valence of the transition metal. For example, x may be from 1 to 4.

In one embodiment, the transition metal may be selected from Groups IV through VIB (e.g., titanium, chromium or vanadium), for example. In one embodiment, R may be selected from chlorine, bromine, carbonates, esters or alkoxy groups, for example. Examples of catalyst components include TiCl₄, TiBr₄, Ti(OC₂H₅)₃Cl, Ti(OC₃H₇)₂Cl₂, Ti(OC₆H₁₃)₂Cl₂, Ti(OC₂H₅)₂Br₂ and Ti(OC₁₂H₂₅)Cl₃, for example.

Those skilled in the art will recognize that a catalyst may be “activated” in some way before it is useful for promoting polymerization. As discussed further below, activation may be accomplished by contacting the catalyst with an activator (e.g., a Z-N activator,) which is also referred to in some instances as a “cocatalyst.” Embodiments of such Z-N activators include organoaluminum compounds, such as trimethyl aluminum (TMA), triethyl aluminum (TEAl) and triisobutyl aluminum (TiBAl), for example.

The Ziegler-Natta catalyst system may further include one or more electron donors, such as internal electron donors and/or external electron donors. Internal electron donors may be used to reduce the atactic form of the resulting polymer, thus decreasing the amount of xylene solubles in the polymer, for example. The internal electron donors may include amines, amides, esters, ketones, nitriles, ethers, phosphines, diethers, succinates, thalates, or dialkoxybenzenes, for example. (See, U.S. Pat. No. 5,945,366 and U.S. Pat. No. 6,399,837, which are incorporated by reference herein.)

External electron donors may be used to further control the amount of atactic polymer produced, for example. The external electron donors may include monofunctional or polyfunctional carboxylic acids, carboxylic anhydrides, carboxylic esters, ketones, ethers, alcohols, lactones, organophosphorus compounds and/or organosilicon compounds, for example. In one embodiment, the external donor may include diphenyldimethoxysilane (DPMS), cyclohexymethyldimethoxysilane (CDMS), diisopropyldimethoxysilane and/or dicyclopentyldimethoxysilane (CPDS), for example. The external donor may be the same or different from the internal electron donor used.

The components of the Ziegler-Natta catalyst system (e.g., catalyst, activator and/or electron donors) may or may not be associated with a support, either in combination with each other or separate from one another. The Z-N support materials may include a magnesium dihalide, such as magnesium dichloride or magnesium dibromide, or silicon, for example.

The Ziegler-Natta catalyst may be formed by any method known to one skilled in the art. For example, the Ziegler-Natta catalyst may be formed by contacting a transition metal halide with a metal alkyl or metal hydride. (See, U.S. Pat. No. 4,298,718, U.S. Pat. No. 4,298,718, U.S. Pat. No. 4,544,717, U.S. Pat. No. 4,767,735, and U.S. Pat. No. 4,544,717, which are incorporated by reference herein.)

Metallocene catalysts may be characterized generally as coordination compounds incorporating one or more cyclopentadienyl (Cp) groups (which may be substituted or unsubstituted, each substitution being the same or different) coordinated with a transition metal through π bonding.

The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

A specific, non-limiting, example of a metallocene catalyst is a bulky ligand metallocene compound generally represented by the formula:
[L]ₘM[A]ₙ;
wherein L is a bulky ligand, A is a leaving group, M is a transition metal and m and n are such that the total ligand valency corresponds to the transition metal valency. For example m may be from 1 to 3 and n may be from 1 to 3.

The metal atom “M” of the metallocene catalyst compound, as described throughout the specification and claims, may be selected from Groups 3 through 12 atoms and lanthanide Group atoms, or from Groups 3 through 10 atoms or from Sc, Ti, Zr, Hf, V, Nb, Ta, Mn, Re, Fe, Ru, Os, Co, Rh, Ir and Ni, for example. The oxidation state of the metal atom “M” may range from 0 to +7 or is +1, +2, +3, +4 or +5, for example. The groups bound to the metal atom “M” are such that the compounds described below in the formulas and structures are electrically neutral, unless otherwise indicated.

The bulky ligand generally includes a cyclopentadienyl group (Cp) or a derivative thereof. The Cp ligand(s) form at least one chemical bond with the metal atom M to form the “metallocene catalyst.” The Cp ligands are generally distinct from the leaving groups bound to the catalyst compound in that they are not highly susceptible to substitution/abstraction reactions.

Cp ligands may include ring(s) or ring system(s) including atoms selected from group 13 to 16 atoms, such as carbon, nitrogen, oxygen, silicon, sulfur, phosphorous, germanium, boron, aluminum and combinations thereof, wherein carbon makes up at least 50% of the ring members. Non-limiting examples of the ring or ring systems include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl or “H₄Ind”), substituted versions thereof and heterocyclic versions thereof, for example.

Cp substituent groups may include hydrogen radicals, alkyls (e.g., methyl, ethyl, propyl, butyl, pentyl, hexyl, luoromethyl, fluroethyl, difluroethyl, iodopropyl, bromohexyl, benzyl, phenyl, methylphenyl, tert-butylphenyl, chlorobenzyl, dimethylphosphine and methylphenylphosphine), alkenyls (e.g., 3-butenyl, 2-propenyl and 5-hexenyl), alkynyls, cycloalkyls (e.g., cyclopentyl and cyclohexyl), aryls (e.g., trimethylsilyl, trimethylgermyl, methyldiethylsilyl, acyls, aroyls, tris(trifluoromethyl)silyl, methylbis(difluoromethyl)silyl and bromomethyldimethylgermyl), alkoxys (e.g., methoxy, ethoxy, propoxy and phenoxy), aryloxys, alkylthiols, dialkylamines (e.g., dimethylamine and diphenylamine), alkylamidos, alkoxycarbonyls, aryloxycarbonyls, carbomoyls, alkyl- and dialkyl-carbamoyls, acyloxys, acylaminos, aroylaminos, organometalloid radicals (e.g., dimethylboron), Group 15 and Group 16 radicals (e.g., methylsulfide and ethylsulfide) and combinations thereof, for example. In one embodiment, at least two substituent groups, two adjacent substituent groups in one embodiment, are joined to form a ring structure.

Each leaving group “A” is independently selected and may include any ionic leaving group, such as halogens (e.g., chloride and fluoride), hydrides, C₁ to C₁₂ alkyls (e.g., methyl, ethyl, propyl, phenyl, cyclobutyl, cyclohexyl, heptyl, tolyl, trifluoromethyl, methylphenyl, dimethylphenyl and trimethylphenyl), C₂ to C₁₂ alkenyls (e.g., C₂ to C₆ fluoroalkenyls), C₆ to C₁₂ aryls (e.g., C₇ to C₂₀ alkylaryls), C₁ to C₁₂ alkoxys (e.g., phenoxy, methyoxy, ethyoxy, propoxy and benzoxy), C₆ to C₁₆ aryloxys, C₇ to C₁₈ alkylaryloxys and C₁ to C₁₂ heteroatom-containing hydrocarbons and substituted derivatives thereof, for example.

Other non-limiting examples of leaving groups include amines, phosphines, ethers, carboxylates (e.g., C₁ to C₆ alkylcarboxylates, C₆ to C₁₂ arylcarboxylates and C₇ to C₁₈ alkylarylcarboxylates), dienes, alkenes (e.g., tetramethylene, pentamethylene, methylidene), hydrocarbon radicals having from 1 to 20 carbon atoms (e.g., pentafluorophenyl) and combinations thereof, for example. In one embodiment, two or more leaving groups form a part of a fused ring or ring system.

The metallocene catalysts may be activated with a metallocene activator for subsequent polymerization, for example. This may involve the abstraction of at least one leaving group (A group in the formulas/structures above, for example) from the metal center of the catalyst component. The metallocene catalysts are thus activated towards olefin polymerization using such activators.

Embodiments of such activators include Lewis acids, such as cyclic or oligomeric polyhydrocarbylaluminum oxides, non-coordinating ionic activators “NCA”, ionizing activators, stoichiometric activators, combinations thereof or any other compound that may convert a neutral metallocene catalyst component to a metallocene cation that is active with respect to olefin polymerization.

The Lewis acids may include alumoxane (e.g., “MAO”), modified alumoxane (e.g., “TIBAO”) and alkylaluminum compounds, for example. Non-limiting examples of aluminum alkyl compounds may include trimethylaluminum, triethylaluminum, triisobutylaluminum, tri-n-hexylaluminum and tri-n-octylaluminum, for example.

Ionizing activators are well known in the art and are described by, for example, Eugene You-Xian Chen & Tobin J. Marks, Cocatalysts for Metal-Catalyzed Olefin Polymerization: Activators, Activation Processes, and Structure-Activity Relationships 100(4) CHEMICAL REVIEWS 1391-1434 (2000). Examples of neutral ionizing activators include Group 13 tri-substituted compounds, in particular, tri-substituted boron, tellurium, aluminum, gallium and indium compounds and mixtures thereof (e.g., tri(n-butyl)ammonium, tetrakis(pentafluorophenyl)boron and/or trisperfluorophenyl boron metalloid precursors), for example. The substituent groups may be independently selected from alkyls, alkenyls, halogen, substituted alkyls, aryls, arylhalides, alkoxy and halides, for example. In one embodiment, the three groups are independently selected from halogens, mono or multicyclic (including halosubstituted) aryls, alkyls, alkenyl compounds and mixtures thereof, for example. In another embodiment, the three groups are selected from C₁ to C₂₀ alkenyls, C₁ to C₂₀ alkyls, C₁ to C₂₀ alkoxys, C₃ to C₂₀ aryls and combinations thereof, for example. In yet another embodiment, the three groups are selected from the group highly halogenated C₁ to C₄ alkyls, highly halogenated phenyls, and highly halogenated naphthyls and mixtures thereof, for example. By “highly halogenated”, it is meant that at least 50% of the hydrogens are replaced by a halogen group selected from fluorine, chlorine and bromine.

The activators may or may not be associated with or bound to a support, either in association with the catalyst (e.g., metallocene) or separate from the catalyst component, such as described by Gregory G. Hlatky, Heterogeneous Single-Site Catalysts for Olefin Polymerization 100(4) CHEMICAL REVIEWS 1347-1374 (2000).

Metallocene Catalysts may be supported or unsupported. Typical support materials may include talc, inorganic oxides, clays and clay minerals, ion-exchanged layered compounds, diatomaceous earth compounds, zeolites or a resinous support material, such as a polyolefin, for example.

Specific inorganic oxides include silica, alumina, magnesia, titania and zirconia, for example. The inorganic oxides used as support materials may have an average particle size of from 30 microns to 600 microns or from 30 microns to 100 microns, a surface area of from 50 m²/g to 1,000 m²/g or from 100 m²/g to 400 m²/g and a pore volume of from 0.5 cc/g to 3.5 cc/g or from 0.5 cc/g to 2 cc/g, for example.

Methods for supporting metallocene catalysts are generally known in the art. (See, U.S. Pat. No. 5,643,847, U.S. Pat. Nos. 09184358 and 09184389, which are incorporated by reference herein.)

The polymers (and blends thereof) that may be formed via the processes described herein may include, but are not limited to, linear low density polyethylene, elastomers, plastomers, high density polyethylenes, low density polyethylenes, medium density polyethylenes, polypropylene (e.g.,. syndiotactic, atactic and isotactic) and polypropylene copolymers, for example.

The polymers and blends thereof are useful in applications known to one skilled in the art, such as forming operations (e.g., film, sheet, pipe and fiber extrusion and co-extrusion as well as blow molding, injection molding and rotary molding). Films may include blown or cast films formed by co-extrusion or by lamination, for example. Such films may be useful as shrink films, cling films, stretch films, sealing films, oriented films, snack packaging, heavy duty bags, grocery sacks, baked and frozen food packaging, medical packaging, industrial liners, and membranes, for example. Fibers may include melt spinning, solution spinning and melt blown fiber operations for use in woven or non-woven, for example. Such fibers may be useful to make filters, diaper fabrics, medical garments and geotextiles, for example. Extruded articles may include medical tubing, wire and cable coatings, geomembranes and pond liners, for example. Molded articles may include single and multi-layered constructions in the form of bottles, tanks, large hollow articles, rigid food containers and toys, for example.

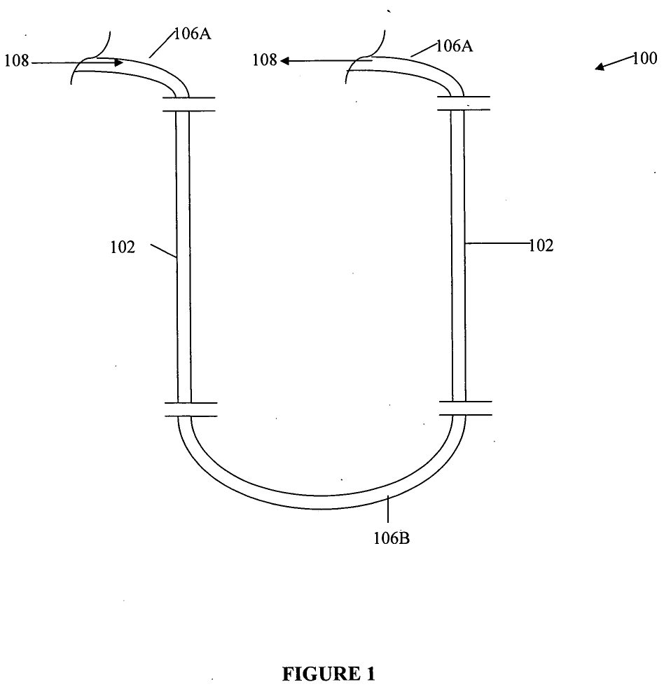

FIG. 1 illustrates a portion of a loop reactor 100.

The loop reactor 100 generally includes a plurality of vertical segments 102 and horizontal segments 106 with a process stream 108 passing therethrough. The horizontal segments 106 generally include an upper horizontal segment 106A and a lower horizontal segment 106B. Such vertical and horizontal segments may be configured in any manner known to one skilled in the art and may include any number of portions within each segment. For example, such segments may be curved segments with portions that may be substantially horizontal or such segments may be formed into substantially continual curves so that the loop reactor 100 contains essentially no horizontal flow paths or elbows. In one embodiment, each segment may be operably connected to the next segment in the flow path by a smooth bend or elbow, thus providing a continuous flow path that is substantially free from internal obstructions. In addition, each segment may be operably connected to the next segment by any method known to one skilled in the art, such as flanges, for example. Further, each segment (e.g., the vertical and horizontal segments) may be formed of a continuous segment or may be formed of multiple segments.

The temperature (e.g., the reaction temperature) of the loop reactor 100 may be controlled by any method known to one skilled in the art. For example, the vertical segments 102 may be formed by shell and tube heat exchangers (e.g., a jacketed pipe.)

The process stream 108 is generally continuously circulated through the loop reactor 100 during the polymerization reaction. This circulation may be accomplished via the placement of a circulating pump (not shown) in operable communication with the loop reactor 100.

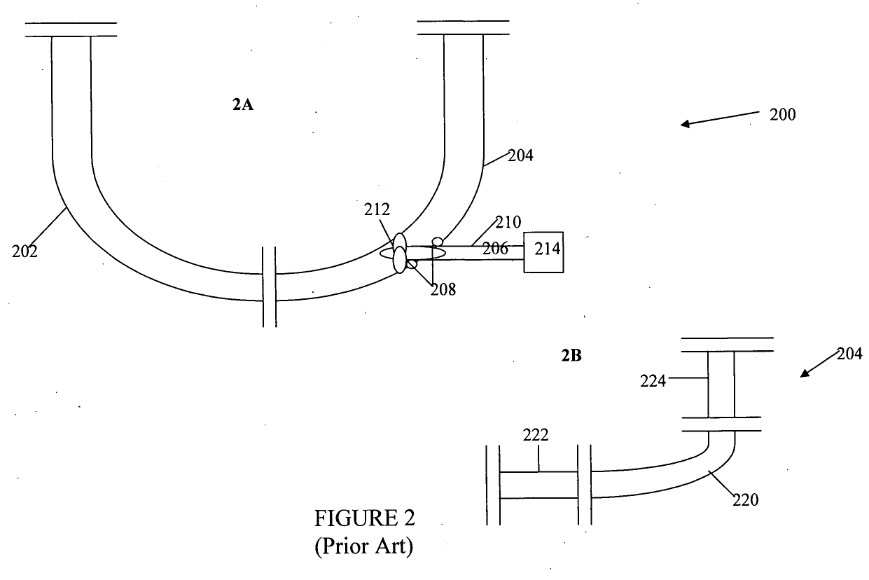

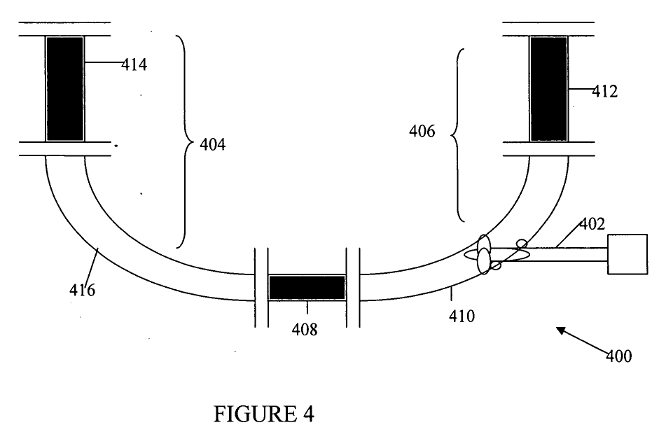

FIG. 2 illustrates a circulating pump 206 and placement of such pump 206 within a loop reactor. The circulating pump 206 is placed within a lower horizontal segment 200. While illustrated as including a first segment 202 and a second segment 204, such lower horizontal segment 200 may include any number of segments and arrangement thereof. In one embodiment, the circulating pump 206 is generally disposed within the second segment 204, although it may be disposed within either segment. When disposed in the first segment 202, the loop reactor and segments thereof are essentially a mirror image of that shown in the Figures (e.g., FIGS. 2 and 4.) Further, it is contemplated that loop reactor systems may include a plurality of pumps, one or more of which may be in-line pumps, described in further detail below.

Such circulating pumps 206 generally include an impeller 212, which is operably connected to a motor 214 via a shaft 210. The second segment 202 is generally adapted to incorporate the circulating pump 206 therein, such as disposing the shaft 210 in an aperture formed in the second segment 202. The junction of the shaft 210 and the aperture is sealed 208 to prevent polymer and other chemicals from passing therethrough. Unfortunately, such seals have a limited lifetime, often requiring maintenance, which may lead to lost production time and potentially hazardous conditions, for example.

In order to accommodate the circulating pump 206, the second segment 204 may include multiple operably connected sections, such as a pump portion 220 (pump not shown), an inlet portion 222 and an outlet portion 224, for example. See, FIG. 2B. As stated above, the first segment 202 may be a mirror image of the segment 204. In an alternative embodiment (not shown,) the second segment may not include segment 222, for example.

Unexpectedly, it has been found that circulating pumps may be incorporated into loop reactors without the need for seals through the use of in-line pumps. In one embodiment, the in-line pump generally includes two concentric cylinders. The outer cylinder generally contains the pump stator, while the inner cylinder contains the pump rotor. Such impellers are generally connected to a central hub and extend out to, and connect with, the inner cylinder. When power is supplied to the stator, an electromagnetic field is generated causing the inner cylinder, including the impeller to rotate. The inner and outer cylinders are sealed or “canned” in order to prevent fluid from coming in contact with the internal mechanisms of the rotor and stator. Generally, there exists a small gap between the inner and outer cylinders, which can be filled with water in order to cool the rotor and stator.

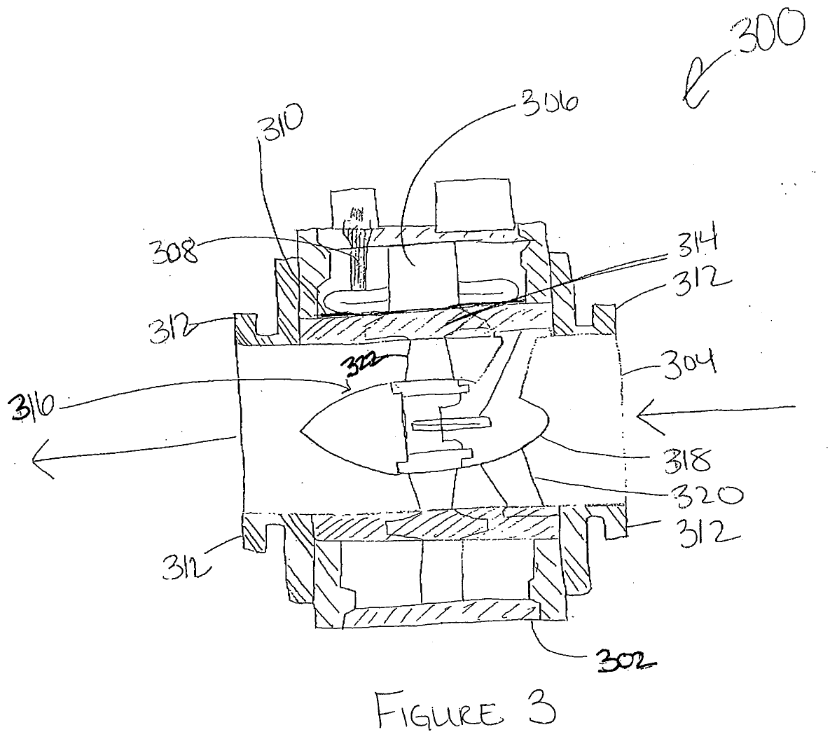

FIG. 3 illustrates a specific embodiment of an in-line pump 300. The in-line pump 300 generally includes a substantially cylindrical housing 302 including a substantially cylindrical passage 304 extending therethrough. The housing 302 further includes flanges 312 for connecting the housing 302 to the segments of the loop reactor.

The in-line pump 300 further includes a hermetically sealed stator 306 mounted inside the housing. The stator 306 includes a terminal gland 308 thereon for connecting the stator 306 to a source of electrical power located outside the loop reactor. The stator 306 is hermetically sealed by a stator can 310.

The impeller assembly 316 is rotatably mounted inside the passage 304 of the housing 302. The impeller assembly 316 includes an impeller 322 and a rotor 314 mounted around the perimeter of the impeller 322 on a cylindrical shaft (not shown.) The rotor 314 is hermetically sealed by a rotor can (not shown.)

The impeller 322 includes a plurality of blades 320 mounted on and extending radially outward from a cylindrical hub 318.

Although a specific embodiment of a pump is illustrated in FIG. 3, any “in-line” type pump may be utilized in the embodiments described herein.

FIG. 4 illustrates potential locations for the in-line pump within a loop reactor. Such locations are indicated by the shaded portions of the figure. Generally, the in-line pump (not shown) may be incorporated into the lower vertical segment 400 of a loop reactor. Such placement generally provides for easier maintenance because the pump would be accessible from the ground level. As stated previously, the lower horizontal segment may be reversed (i.e., a mirror image.)

In the case of retrofitted plants, such loop reactors may already include a conventional-type circulating pump, such as pump 402. When circulating pumps are already incorporated into a loop reactor, such pump may be abandoned in place (e.g., replace the impeller with a dummy impeller so that the pump is no longer operable) or may be removed from the loop reactor and replaced with a replacement segment.

Referring back to FIG. 4, the lower horizontal segment 400 generally includes a first segment 404 and a second segment 406. As described in FIG. 3, the second segment 406 may include an inlet portion 408, a pump portion 410 and an outlet portion 412, each in operable communication (or a pump portion and an outlet portion, the pump portion in operable communication with segment 416.) Such an embodiment generally includes a circulating pump 402, which may be abandoned in place. Such abandonment may reduce the down time and costs associated with such replacement. The first segment 404 may further be formed of multiple sections in operable communication, such as a first inlet segment 414 and a second inlet segment 416.

It is contemplated that the in-line pump may be placed in any location within the loop reactor, such as the segment 412, 408 or 414, for example.

It is further contemplated that an alternative section of the lower horizontal segment 400 (a section not including the in-line pump) may be formed of a heat exchanger, such as a shell and tube heat exchanger, to control the heat output from the in-line pump. Excess heat production from the in-line pump may decrease the reactor capacity if not removed from the loop reactor and therefore additional cooling/heat removal capacity may be needed.

Further, when retrofitting an existing loop reactor, it is contemplated that those reactors that do not have multiple sections within each segment, and in particular in the lower horizontal segment, may require adjustment of the length of the one or more vertical and/or horizontal segments. Alternatively, the in-line pump may actually be placed in a vertical section.

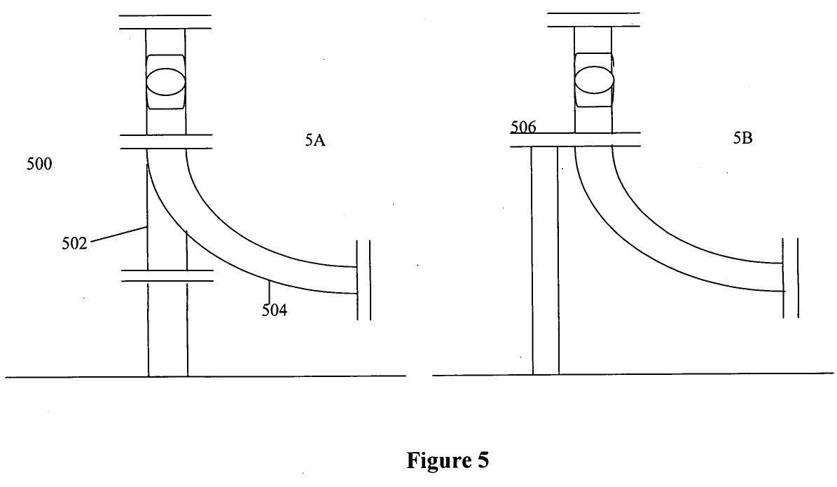

The loop reactor may further include a support, generally to support any additional weight of pump. Embodiments of supports are illustrated in FIG. 5. In one embodiment (see, FIG. 5A,) the support assembly 500 includes a pipe segment 502 operably connected to the lower horizontal segment 504 (e.g., welded or bolted). In one particular embodiment, a spring may operably connect the pipe segment to the lower horizontal segment. This may include an elbow support, for example. The support assembly 500 may further be connected to the ground or another surface via an anchoring device (not shown.) Such anchors may include injection adhesive anchors, for example. However, any assembly capable of supporting the weight of the pump and the reactor may be utilized.

In another embodiment (see, FIG. 5B,) the support assembly 500 is operably connected to the lower horizontal segment 504 by a support plate 506. The support plate may include a separate support plate installed for the purpose of supporting the pump, or the support plate may be a flange that is adapted to attach to the pipe segment to support the pump, for example.

Further, it is contemplated that maintenance of the pump may occur either while the in-line pump is in the loop reactor, or the pump may be removed from the reactor system for maintenance, for example.

What is claimed is:

1. A loop reactor comprising:
a lower horizontal segment, an upper horizontal segment and a vertical segment in operable communication; and
an in-line pump incorporated within the loop reactor.

2. The loop reactor of claim 1, wherein the in-line pump is disposed within the lower horizontal segment.

3. The loop reactor of claim 1, wherein the lower horizontal segment comprises a plurality of segments, the plurality of segments comprising an outlet portion, a first inlet segment and a second inlet segment.

4. The loop reactor of claim 3, wherein the in-line pump is disposed in the outlet portion.

5. The loop reactor of claim 3, wherein the in-line pump is disposed in the first inlet segment.

6. The loop reactor of claim 1, wherein the lower horizontal segment comprises a plurality of segments, the plurality of segments comprising an inlet portion and an outlet portion.

7. The loop reactor of claim 6, wherein the in-line pump is disposed in the inlet portion.

8. The loop reactor of claim 7 further comprising a pump portion operably connected to the inlet portion and the outlet portion.

9. The loop reactor of claim 1 further comprising a support assembly.

10. The loop reactor of claim 9, wherein the support assembly comprises an elbow support.

11. The loop reactor of claim 9, wherein the support assembly comprises a support plate.

12. A polymerization process comprising:
contacting an olefin monomer with a catalyst disposed in a process stream, wherein the process stream is disposed within a loop reactor; and
passing the process stream through an in-line pump to circulate the process stream through the loop reactor.

13. A process for retrofitting a loop reactor with a circulating pump comprising:
adapting a loop reactor comprising a lower horizontal segment, a vertical segment and a pump portion to incorporate an in-line pump therein; and
operably connecting the in-line pump to the loop reactor.

14. The process of claim 13, wherein the adapting comprises shortening a vertical segment and incorporating the in-line pump within the vertical segment.

15. The process of claim 13, wherein the pump portion is abandoned in place.

16. The process of claim 13, wherein the pump portion is removed from the loop reactor.

17. The process of claim 13, wherein the lower horizontal segment comprises a plurality of segments, the plurality of segments comprising an outlet portion, a first inlet segment and a second inlet segment.

18. The process of claim 17, wherein the in-line pump is disposed in the outlet portion.

19. The process of claim 17, wherein the in-line pump is disposed in the first inlet segment.

20. The process of claim 13, wherein the lower horizontal segment comprises a plurality of segments, the plurality of segments comprising an inlet portion and an outlet portion.

21. The process of claim 20, wherein the in-line pump is disposed in the inlet portion.

22. The process of claim 13 further comprising replacing a portion of the lower horizontal segment proximate the pump with a heat exchanger.

23. The process of claim 13 further comprising supporting the in-line pump.

24. The process of claim 23, wherein supporting the in-line pump comprises operably connecting an elbow support to lower horizontal segment.

25. The process of claim 23, wherein supporting the in-line pump comprises operably connecting a support plate disposed proximate the pump to a support assembly.
